(19) United States
(12) Patent Application Publication
(10) Pub. No.: US 2004/0181389 A1
(43) Pub. Date: Sep. 16, 2004

(54) Method and large syntactical analysis system of a corpus, a specialised corpus in particular

(76) Inventors: Didier Bourigault, Pibrac (FR); Cecile Fabre, Toulouse (FR)

Correspondence Address: YOUNG & THOMPSON, 745 SOUTH 23RD STREET 2ND FLOOR, ARLINGTON, VA, 22202

(21) Appl. No.: 10/479,233

(22) PCT Filed: May 28, 2002
(86) PCT No.: PCT/FR02/01779

(30) Foreign Application Priority Data
Jun. 1, 2001 (FR) 01/07287

(51) Int. Cl. G06F 17/20

(52) U.S. Cl. 704/1

(57) ABSTRACT

Method for large syntactical analysis based on unsupervised learning on a corpus comprising an iterative sequencing of two phases: a learning phase wherein linguistic information is acquired using unambiguous analysis cases, and a resolution phase wherein ambiguous analysis cases are resolved using information acquired during the learning phase. The invention is used in particular for creating specialized terminological resources for an information processing system, for creating an ontology for a specialized information search engine on the web, for a terminological lexicon for an automatic translation system, or for a thesaurus for an automatic indexing system.

The present invention relates to a method of broad syntactic analysis of corpora, in particular of specialized corpora. It also relates to a syntactic analysis system employing this method.

Syntactic analysis is the task which consists of automatically identifying the syntactic dependency relationships between the words in a sentence and isolating the syntactic units, called syntagms, of which it is composed. The data treated by a syntactic analyser are here the sentences belonging to a set of texts constituting a corpus. The term syntactic analysis of corpora is used here.

The syntactic relationships which are discussed in this document are very varied: subject of verb, direct object of verb, prepositional complements of verbs, prepositional complements of nouns, prepositional complements of adjectives, antecedents of relative pronouns, epithetical adjectives, predicate of the subject, predicate of the object. This is why the term “broad” syntactic analysis is used here. In general, syntactic analysis tools have a much smaller coverage.

“Chunk parsing” tools are already known, for example from the document WO 062155A1, which are limited to the tagging of syntagms either of minimum size (“base noun phrase”), or of maximum size, without identifying the dependency relationships within these extracted syntagms or the dependence relationships in which these syntagms are included.

LEXTER software uses only an extraction of nominal syntagms, no analysis around the verb, the dependence relationships are found solely within the nominal group, but there is complete analysis of the nominal syntagm.

The technique known as “Shallow parsing” also exists: the subject and direct object relationships of the verb are tagged, but there is no interest in group detail, the prepositional linkages are disregarded.

A specialized corpus is a set of texts relating to a specialized area or a particular technique. Every corpus of this type is characterized on the one hand by a certain thematic homogeneity and on the other by great syntactic complexity: these corpora are written in a technical jargon which uses relatively long technical terms and considerable syntactic complexity. This makes the automatic syntactic analysis of specialized corpora particularly difficult.

Broad syntactic analysis is a task which is considered to be very complex, particularly because of the numerous cases of ambiguity of prepositional linkage (an example of ambiguity: “I looked at a man with a telescope.”) Experience shows that the performance of data processing systems can reach a satisfactory standard of quality only if they use rich terminological and conceptual knowledge in the area covered by the application. The construction of terminological resources is a very delicate and onerous task which becomes operationally conceivable only with automatic language processing tools, foremost among which are syntactic analysers of specialized corpora:

As none of the current syntactic analysis methods allows resolution of the question of broad syntactic analysis, the aim of the present invention is to propose a method of broad syntactic analysis of corpora, in particular of specialized corpora.

This object is achieved method of broad syntactic analysis based on unsupervised learning on a corpus which can acquire by itself, by analysis of the corpus during processing, a set of linguistic data that it will use to solve the difficult analysis cases. The corpus is at one and the same time the subject of the processing and a source of data.

According to the invention, the method of broad syntactic analysis comprises an iterative sequencing of two phases:

a learning phase in which linguistic data are acquired from unambiguous analysis cases,

a resolution phase in which ambiguous analysis cases are resolved using the data acquired during the learning phase.

The term endogenous learning is used here because the data are acquired by the analyser from the corpus during analysis and directly used by this same analyser on this same corpus to treat the difficult cases.

It is to be noted that learning methods used in data extraction systems exist, as described in particular in document U.S. Pat. No. 5,796,926 in which a learning system constructs new patterns of extraction by recognition of local syntactic relationships between groups of constituents within individual sentences which occur in events to be extracted. This learning system thus generalises extraction patterns which it has learned previously by means of a simple inductive learning of groups of words which can be processed in a way which is synonymous with the patterns. Document U.S. Pat. No. 5,841,895 also discloses in this context a method of learning local syntactic relationships that is used for the learning of patterns of data extraction based on examples.

However, these documents do not describe an unsupervised endogenous recursive learning technique. Moreover, the learning methods described in the two documents cited above require a manual annotation phase during which a human expert links with a great number of sentences examples of structural descriptions of events. It is from these “sentence/event” pairs, constructed manually, that the learning is undertaken.

By contrast, in the method of syntactic analysis according to the invention, there is no manual data preparation phase prior to learning, nor is there an a posteriori validation phase of the data acquired after learning. Learning is carried out directly on the tagged corpus, from unambiguous cases, and the results of this learning are used directly by the analysis.

The learning and resolution phases are sequenced in an iterative way so that the cases resolved during a resolution phase serve as a basis of a new learning phase and so on until no new case is unresolved.

The solution that is the subject of the method of syntactic analysis according to the invention constitutes an alternative to the use of very large-scale linguistic and conceptual knowledge, which it is almost impossible to constitute and update, especially in the specialized areas.

In fact, in the method of syntactic analysis according to the invention, the syntactic analysis is entirely automatic. The data acquired during the endogenous learning phase are directly used by the ambiguity resolution modules without human intervention for manual validation. Statistical criteria are used locally to find a good compromise between the coverage and the accuracy of the data acquired.

The linguistic data are acquired during the endogenous learning phase firstly using unambiguous analysis situations (those where there is only a single candidate for the linkage). These first data are used to resolve a certain number of cases of analysis ambiguity. From the analysis of these new resolved cases, the acquisition module can, in a second pass, acquire new data which will then be used to resolve new residual ambiguity cases.

The method of syntactic analysis according to the invention includes an endogenous learning phase comprising:

a first pass comprising:

an acquisition of linguistic data using unambiguous analysis situations,

a processing of said acquired linguistic data in order to resolve cases of analysis ambiguity,

an analysis of new resolved ambiguity cases,

a second pass comprising:

an acquisition of new linguistic data on ambiguous analysis situations, and

a processing of said acquired new data in order to resolve new residual ambiguity cases.

The principal application aimed at is the construction of specialized terminological resources for a data processing system. The results of the automatic analysis can be used by a human analyst or automatically to construct a terminological resource, for example:

an ontology for a specialized-information search engine on the web

a terminological lexicon for an automatic translation system

a thesaurus for an automatic indexing system

According to another aspect of the invention, a system is proposed for broad syntactic analysis of a corpus, in particular of a specialized corpus using the method according to the invention, comprising

means of acquiring linguistic data within said corpus,

means of processing said acquired linguistic data, and

means of analysing words within said corpus, including learning means.

According to the invention, the data-acquisition means are set up to distinguish between unambiguous analysis cases and ambiguous analysis cases, and the processing means are arranged to process the cases of analysis ambiguity and to provide data allowing residual ambiguity cases to be resolved.

The syntactic analysis system according to the invention can be implemented within a data processing system and can cooperate with data-processing equipment, with data-entry equipment, with data-storage equipment such as databases, and with data-provision and -visualisation equipment.

Other advantages and characteristics of the invention will appear upon examination of the detailed description of an embodiment which is no way limitative, and of the appended drawings in which:

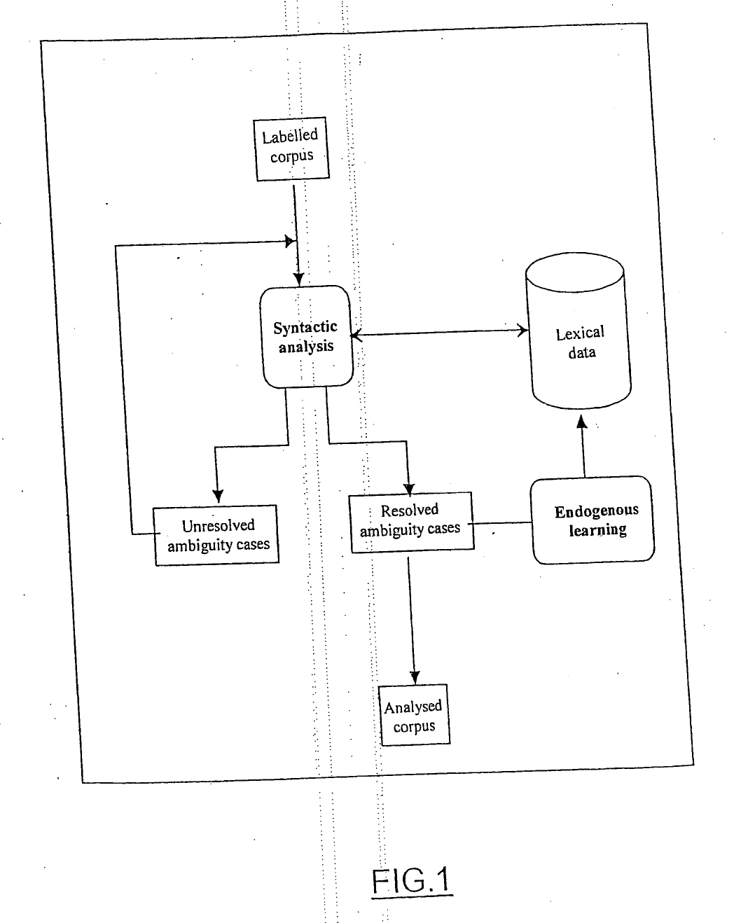

FIG. 1 illustrates the principle of endogenous learning used in the method of syntactic analysis according to the invention; and

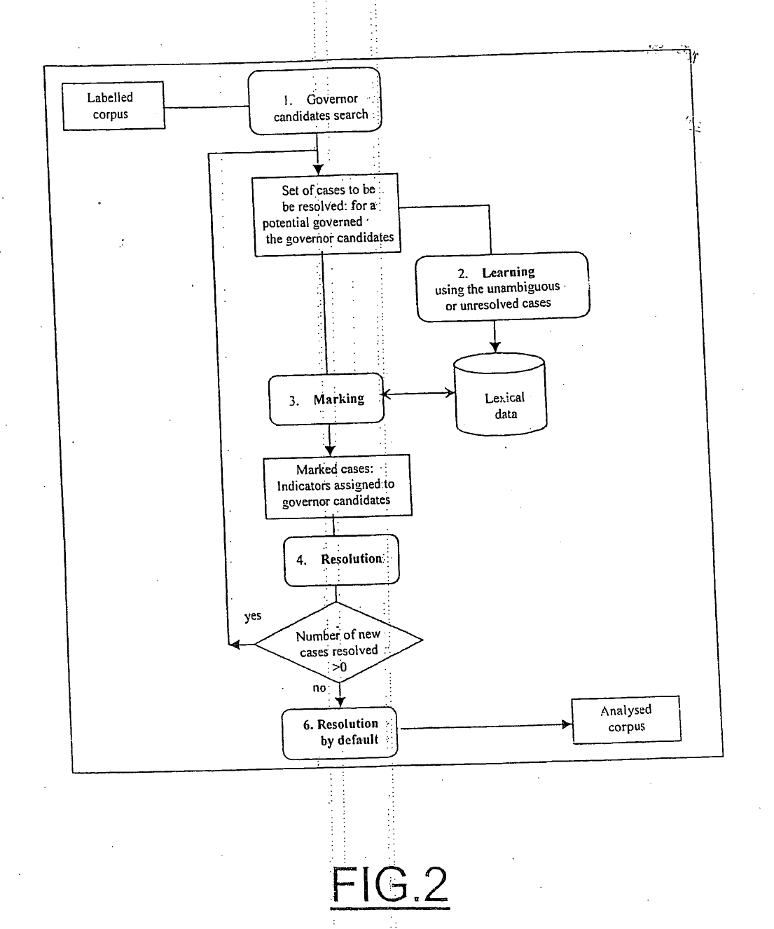

FIG. 2 illustrates the principal stages of an embodiment of the method of syntactic analysis according to the invention.

The general architecture and an example of the use of the method of syntactic analysis according to the invention will now be described. Firstly, a description of the concept of dependency relationship is provided below, in order to better understand the principles used in the method of syntactic analysis according to the invention.

The grammatical structure of a sentence can be described in terms of dependency relationship between words. The relationships involved are those of standard grammar: subject of verb, direct object of verb, indirect object of verb, adjective modifying a noun, etc.

The notations used to describe the principle of endogenous learning are given below. These apply to languages where the concepts of verb, noun, adjective, adverb have meaning.

A dependency relationship can be described as a triplet (X, R, Y) where X is the governor word (the source of the relationship), R is the name of the dependency relationship and Y is the governed word (the target of the relationship).

A list of the principal relationships of dependence is given below:

The SUBJECT relationship: X is a word of the Verb category, and Y is generally a word from the Noun or Pronoun category. Y is the head of the nominal group subject of the verb X.

Le chat dort.

Dependency relationship: (dormir, SUBJECT, chat)

The COMP DIR relationship: X is a word from the Verb category, and Y is generally a word from the Noun or Pronoun category. Y is the head of the nominal group direct object of the verb X.

Le chat mange le souris.

Dependency relationship: (manger, COMP_DIR, souris)

The COMP INDIR relationship: This case covers the phenomenon of indirect complementation. X is a word from the Verb, Noun, Adjective, or Adverb category, and Y is a word from the preposition category. Y is the preposition which introduces the prepositional group complementing X.

Le chatjoue avec la balle.

Dependency relationship: (jouer, COMP_INDIR, avec)

The PREP relationship: X is a word from the Preposition category, and Y is generally a word from the Noun or Verb category. Y is the nominal head of the group introduced by the preposition X.

Le chat joue avec la balle.

Dependency relationship: (avec, PREP, balle)

The MODIF relationship: X is a word from the Noun category, and Y is a word from the Adjective category, and Y is an epithetical adjective of the noun X, or X is a word from the Verb category, and Y is a word from the Adverb category, and Y is an adverb modifying the verb X, etc.

Le chatjoue avec la balle rouge.

Dependency relationship: (balle, MODIF, rouge)

Le chat dort paisiblement.

Dependency relationship: (dormir, MODIF, paisiblement)

In a sentence, a word can be governed only by a single governor for a single relationship, one governor can have several subjects except for certain relationships.

Dependency relationships cannot cross. For example, (X₁, R, X₃) and (X₂, R′, X₄), cannot be followed by X₁, X₂, X₃ and X₄ in this order in the sentence.

The object of the syntactic analysis is to identify a maximum of dependency relationships within each sentence. At the end of the analysis, certain words can be orphans (no governor has been found for them). To complete the syntactic analysis, it is also necessary to identify the anaphoric relationships which form between words in the same sentence, for example, the relationships between a pronoun, relative or personal, and its antecedent.

These relationships can also be described using a triplet (X, ANA, Y), where X is a pronoun and Y its antecedent. The identification of these anaphoric relationships allows the creation of relationships of indirect dependence, using the following inference: (X, R, Y) and (Y, ANA, Z) [symbol] (X, R, Z)

Le chat qui joue avec la bane ( . . . )

(jouer, SUBJECT, qui)

(qui, ANA, chat)

[symbol] (jouer, SUBJECT, chat)

Finally, as regards the COMP_IND and PREP dependency relationships, the following notation convention is adopted: in the case where the dependency relationships R=(X, COMP_IND, prep) and R′=(prep, PREP, Y) have been identified, it will be said that the dependency relationship R″=(X, prep, Y) has been identified.

Le chatjoue avec la balle.

Dependency relationship: (jouer, COMP_IND, avec)

Dependency relationship: (avec, PREP, balle)

Dependency relationship: (jouer, “with”, balle)

An example of organisation of the operations used in the method of syntactic analysis according to the invention will now be described. It is assumed that the entry corpus has undergone a morphosyntactic labelling: a grammatical category (Verb, Nouns, etc.) has been apportioned to each word.

Within the framework of the method of syntactic analysis according to the invention, the syntactic analysis is carried out in two ways:

processing of the dependency relationships from potential governors. In this case, the analysis starts from a governor word and from a dependency relationship and searches for the governed word, For example, since every verb is deemed to have a subject, and only one, the analysis starts from each of the verbs and searches for their governed word;

processing of the dependency relationships from potential governed words. In this case, the analysis starts from a governed word and from a dependency relationship and searches for the governor word. For example, since every preposition is deemed to depend upon a governor, the analysis starts from each of the prepositions and searches for their governor (verb, noun, adjective, adverb).

In both cases, the starting-point is a pivot word (governor, resp. governed) and a dependency relationship and a word is sought which enters into a dependency relationship with it (governed, resp. governor).

The method of syntactic analysis according to the invention includes a stage (0) of acquisition of derivative morphological data, in which is acquired, by analysis of the corpus, word pairs, of different categories, able to be in relationships of morphological derivation. This procedure is based on a small set of rules for truncation/addition of the end parts of words in order to identify potential morphological relationships between words of the corpus (such as for example between the verb fermer and the noun fermeture). These relationships will be used during the syntactic analysis phase with reference to stage (3) below.

The preliminary acquisition stage is followed by a stage (1) of searching for candidates. The syntactic analysis begins thus: for each pivot word, the words which are candidates to be governor (or subject, depending on the mode) are sought. This search runs sequentially through the words of the sentence starting from the pivot word (to the right or to the left depending on the case). The words of suitable grammatical category and syntactic position are adopted as candidates. The search ends when a boundary is encountered. Each candidate is assigned an accessibility coefficient (linked to the distance and to the type of words inserted), which will be used as a decisive indicator in the absence of other indicators or in the case of competition. Moreover, at this stage the incompatible solutions (prohibited crossings of relationships) are identified. The result is a set of cases to resolve: for each of the pivot words, governors or subjects, the list of candidate words.

At the end of stage (1) searching for governor candidates, stage (2), endogenous learning is undertaken during which lexical data are acquired. The cases with a single candidate are regarded as resolved. The triplet constituted by the dependency relationship concerned, the pivot word and the single candidate is recognised. The case is resolved. The cases where several candidates are in competition are called “ambiguous cases”.

A dependency relationship (X, R, Y) is said to have been identified in the corpus if the analyser has tagged this triplet at least once in an unambiguous context.

The basic concept of endogenous learning is to rely on the set of relationships (governor, relationship, governed) identified at this stage in order to acquire data which will then be used in the following stages in order to resolve the ambiguous cases.

Two major types of data are acquired:

complementation data which use a word (verb, noun, adjective, adverb) and a preposition, which indicate that such a word is regularly constructed with such a preposition in the analysed corpus.

distributional proximity data, which use two words of the same category which indicate that such and such a word are semantically close because they are found distributed in identical syntactic contexts in the analysed corpus.

The complementation data are given in the form of what are called productivity coefficients. The distributional proximity data are given in the form of what are called proximity coefficients. The concepts of productivity and proximity are at the heart of the principle of endogenous learning.

The concept of “Governor productivity” used in the method of syntactic analysis according to the invention will now be defined. The governor productivity of a triplet constituted by a word M, from a preposition Prep and a category C is the number of different words Y, of category C, for which the dependency relationship (M, Prep, Y) has been identified.

By way of example:

If the analyser encounters the unambiguous contexts “disparaître sous les alluvions épaisses” and “disparaître sous les débris”, it identifies the relationships of dependence (disparaître, “sous”, alluvions) and (disparaître, “sous”, debris). The governor productivity of the triplet (disparaître, sous, Noun) is 2.

If the analyser encounters the unambiguous contexts “machine à laver” and “machine àsécher”, the governor productivity of the triplet (machine, à, verb) is 2.

The concept of “governed productivity” which is also used in the method of syntactic analysis according to the invention will now be defined. The governed productivity of a triplet constituted by a word M, a preposition Prep and a category C is the number of different words X, of category C, such that the dependency relationship (X, Prep, M) has been identified.

By way of example:

If the analyser encounters the unambiguous contexts “granit à grains épais” and “grès à gros grains”, it identifies the dependency relationship (granit, “à”, grain) and (grès, “à”, grain). The governed productivity of the triplet (grain, à, Noun) is 2.

The concepts of “first-order syntactic context”, “second-order syntactic context”- and “governed proximity” will now be defined.

A “first-order syntactic context” is a pair (M, REL) where M is a word and REL a dependency relationship. A word X has been found in a syntactic context (M, REL) if, and only if, the dependency relationship (M, REL, X) has been identified.

By way of examples:

the syntactic context (manger, SUBJECT) refers to the subject position of the verb manger. The syntactic context (balle, MODIF) refers to the epithetical position of the noun balle. The syntactic context (disparaître, sous) refers to the indirect object position in sous of the verb disparaître.

A second-order syntactic context is a quadruplet (M₁, M₂, REL₁, REL₂) where M₁ and M₂ are words, and REL₁ and REL₂ relationships of dependence. A word X has been found in a second-order syntactic context (M₁, M₂, REL₁, REL₂) if, and only if, the dependency relationships (M₂, REL₁, M₁) and (M₂, REL₂, X) have been identified.

By way of examples:

The second-order syntactic context (chat, manger, SUBJ, DIR._OBJ) refers to the direct-object complement position of the verb manger when this is constructed with the word chat as subject. If the two relationships of dependence (manger, SUBJ, chat), and (manger, OBJ, souris) have been identified, the word souris has been found in the second-order syntactic context (manger, chat, SUBJ, DIR_OBJ) and the word chat has been found in the second-order syntactic context (manger, souris, DIR._OBJ, SUBJ.)

X and Y are two words of the same category. Let N₁(X, Y) be the number of first-order syntactic contexts in which X and Y have each been found, and N₂ (X₁ Y) the number of second-order syntactic contexts in which X and Y have each been found. The subject proximity between X and Y is the result of a linear combination of N₁ and of N₂:subject proximity (X, Y)=a₁. N₁(X, Y)+a₂. N₂ (X, Y)

By way of examples:

If the analyser encounters the unambiguous contexts “disparaître sous les alluvions” and “disparaître sous les débris”, as well as “tailler dans les alluvions” and “tailler dans les débris”, it finds the nouns alluvions and débris in the syntactic contexts (disparaître, sous, Noun) and (tailler, dans, Noun). The number of first-order syntactic contexts in which alluvions and debris have each been found is equal to 2: N₁ (alluvions, débris)=2.

a and b are parameters. b is systematically greater than a.

A word X is a close governed of the word Y if, and only if, the subject proximity between X and Y is above a certain threshold.

The concept of “governor proximity” will now be defined. Let (M₁, R₁) and (M₂, R₂) be two syntactic contexts. The governor proximity between these two contexts is equal to the number of words which have been found in the context (M₁, R₁) and in the context (M₂, R₂).

By way of examples:

If the analyser encounters the unambiguous contexts “disparaître sous les alluvions” and “disparaître sous les débris”, as well as “tailler dans les alluvions” and “tailler dans les débris”, it finds the nouns alluvions and debris in the syntactic contexts (disparaître, sous) and (tailler, dans). The governor proximity between (disparaítre, sous) and (tailler, dans) is equal to 2.

A syntactic context is a close governor of a given syntactic context if, and only if, their governor proximity is above a certain threshold.

It is to be noted that frequency does not play a part. One of the most original characteristics of the solution presented here is that the frequency of occurrence of the words or the dependency relationships is not a matter of priority in the calculation of the acquired data.

The stage (3) of marking the candidates with the method of syntactic analysis according to the invention will now be described.

For each ambiguous case, each of the candidates is reviewed and is marked with a certain number of indicators the values of which are calculated from data acquired during the endogenous learning phase.

For each case, the dependency relationship is designated R. The pivotal word is either a governor or a governed. If the pivotal word is a governor, the candidates are governed candidates. If the pivot word is a governed, the candidates are governor candidates. For each case, for each candidate:

the governor is designated Rr. If the pivotal word is a governor, Rr is the pivot word for all the candidates of the case, if the pivot word is a governed, Rr is itself the candidate. The category of the governor word Rr is designated Cr.

the governor is designated Ri. If the pivot word is a governed, Ri is the pivot word for all the candidates of the case, if the pivot word is a governor, Ri is itself the candidate. The category of Ri is designated Ci. NB: in the case where the relationship is PREP, the governed is the word which the preposition governs (and not the preposition itself), and the relationship R has as its value the preposition itself.

Each candidate of each of the cases is assigned a certain number of indicators. A distinction is made between direct indicators and derived indicators are distinguished. Direct indicators are calculated from data acquired using the candidate and using the pivot word themselves. The derived indicators are calculated from data acquired using morphological derived words (cf. phase 0) linked to the candidate or to the pivot word.

Some direct indicators used in the stage of marking of the candidates are presented below:

REL Indicator. If the dependency relationship (Rr, R, Ri) has been identified, the candidate is assigned a REL indicator at 1, if not at zero.

ProDGovernor Indicator. Is used only if the dependency relationship is COMP_IND. Let Prep be the preposition. The indicator is equal to the governor productivity of the triplet (Rr, Prep, Ci).

ProDGoverned Indicator. Used only if the dependency relationship is COMP_IND. Let Prep be the preposition. The indicator is equal to the subject productivity of the triplet (Ri, Prep, Cr).

ProXGoverned Indicator. This indicator is equal to the number of close governed of Ri which have been found in the syntactic context (Rr, R)

ProXGovernor Indicator. This indicator is equal to the number of close governor syntactical contexts of (Rr, R) in which Ri has been found.

Derived indicators used in the stage of marking the candidates are presented below. The derived indicators are calculated from data acquired using morphological derived words linked to the candidate and to the pivot word. Because there are very many figures, only two illustrative examples of derived indicators will be described here:

ProDGovernor NV Indicator: the case in which the dependency relationship is the preposition Prep, the governor candidate is the noun N and the category of the subject is Noun. If the candidate N has a verb V as morphological derivative a verb V, then the ProDGovernor NV Indicator for this candidate is equal to the governor productivity of the triplet (V, Prep, Noun).

By way of example:

The candidate is the noun écriture, the preposition is sur, the relationship of morphological derivation between écriture and écriture has been acquired. The direct ProDGovernor indicator is the governor productivity of the noun écriture with the preposition sur, the derived ProDGovernor NV indicator is the governor productivity of the verb écrire with the preposition sur.

REL_VavNAj Indicator the case in which the dependency relationship is MODIF, the governor candidate is the verb V, the governed is the adverb Av. If the candidate V has as its morphological derivative a noun N and if the adverb Av has as its morphological derivative an adjective Aj, then the REL_VAvNAj indicator for this candidate is equal to 1 if the dependency relationship (N, MODIF, Aj) has been identified. Example:

The governor candidate is the verb imprimer, the subject is the adverb rapidement, the morphological derivation relationships between imprimer and impression on the one hand and between rapidement and rapide on the other hand have been acquired. The direct REL indicator is worth 1 if the dependency relationship (imprimer, MODIF, rapidement) has been identified, the derived REL_VavNAj indicator is worth 1 if the dependency relationship (impression, MODIF, rapide) has been identified.

The stage (3) of marking is followed by a stage (4) of resolution of the method of syntactical analysis according to the invention.

If the data acquired during the endogenous learning phase (phase 2) have not contributed to marking any candidate during the marking phase (phase 3), the process ends with the phase of resolution by default (phase 5).

Otherwise, new indicators are assigned. A certain number of new cases are resolved using these new indicators and taking into account the incompatible solutions and the accessibility coefficients. Cases initially judged ambiguous can become unambiguous if certain acquired data eliminate candidates.

Different types of strategy and rules of resolution using the results of the endogenous learning can be envisaged. If new cases have been resolved, a new endogenous learning phase (phase 2) is launched. Otherwise the process ends with the phase of resolution by default (phase 5).

The method of syntactical analysis according to the invention can also include a resolution by default in which the cases are dealt with where none of the candidates has an indicator. Amongst the rules of resolution, some are acquired by endogenous learning for all of the resolved cases, the linkage probabilities are calculated as a function of the configuration of the case, described using the dependency relationship, the category of the pivot word and the sequence of the categories of the candidates.

Of course, the invention is not limited to the examples which have just been described and numerous amendments can be made to these examples without exceeding the scope of the invention. In particular a number of analysis and learning iterations greater than two can be envisaged. Moreover, the method of syntactic analysis according to the invention is not limited to the French language alone but can be advantageously applied to many other languages.

1. Method of broad syntactic analysis based on unsupervised learning using a corpus, characterized in that it comprises an iterative sequencing of two phases:
a learning phase, in which the linguistic data are acquired from unambiguous analysis cases,
a resolution phase, in which ambiguous analysis cases are resolved using the data acquired during the learning phase.

2. Method of broad syntactic analysis of a corpora, in particular of a specialized corpora, according to claim 1, characterized in that the phases of learning and of resolution follow each other in an iterative way so that the resolved cases during a resolution phase serve as a basis for a new learning phase, and so on until no new case is not resolved.

3. Method according to claim 2, characterized in that it also comprises sequences of identification of relationships of dependence between words of the corpus in which each dependency relationship is described in the form of a triplet (X, R, Y) where X is the governor word (the source of the relationship), R is the noun of the dependency relationship and Y is the governed word (the target of the relationship), and in which each anaphoric relationship is described in the form of a triplet (X, ANA, Y), where X is a pronoun, ANA is the noun of the anaphoric relationship and Y its antecedent, the identification of these anaphoric relationships allowing the updating of indirect-dependency relationships.

4. Method according to claim 3, characterized in that it is applied to an entry corpus which has previously undergone a morphosyntatic labelling.

5. Method according to one of claims 3 or 4, characterized in that the processing of dependency relationships is based on potential governors.

6. Method according to one of claims 3 or 4, characterized in that the processing of the dependency relationships is based on potential governed.

7. Method according to one of claims 5 or 6, characterized in that in a sequence of identification of dependency relationship, the starting point is a pivot word (governor or governed respectively) and a dependency relationship and a word is sought which enters into a dependency relationship with it (subject or governor respectively).

8. Method according to claim 7, characterized in that it also comprises a stage (0) of acquisition of data comprising an acquisition of earlier derivative morphological data in which, by analysis of the corpus, word pairs are acquired, from different categories, which are able to be in a relationship of morphological derivation.

9. Method according to claim 8, characterized in that the acquisition stage (0) is followed by a searching stage (1), for each pivot word (governor, governed respectively), candidate words to be governed (or governor).

10. Method according to claim 9, characterized in that the stage (1) of searching includes running sequentially through the words of a sentence starting from the pivot word.

11. Method according to claim 10, characterized in that at the end of the stage (1) of searching, each adopted candidate is assigned a coefficient of accessibility linked to the distance from the pivot word and to the type of words inserted between said candidate and said pivot word.

12. Method according to one of claims 9 to 11, characterized in that the stage (1) of searching includes an identification of the incompatible solutions.

13. Method according to one of claims 9 to 12, characterized in that the stage (1) of searching is followed by a stage (2) of endogenous learning comprising:
a recognition of triplets each constituted by a pivot word, a dependency relationship and a single candidate, leading to what are called resolved cases,
a recognition of triplets each constituted by a pivot word, a dependency relationship and several competing candidates, leading to what are called ambiguous cases.

14. Method according to claim 13, characterized in that the stage of endogenous learning includes an acquisition of data called complementation involving a word and a preposition in the analysed corpus, and an acquisition of distributional proximity data involving two words of the same category that are semantically close and distributed in more or less identical syntactic contexts in the analysed corpus.

15. Method according to claim 14, characterized in that the complementation data comprise what are called productivity coefficients and the distributional proximity data comprise what are called proximity coefficients.

16. Method according to claim 15, characterized in that the productivity coefficients include a governor productivity coefficient that corresponds, for a triplet constituted by a word M, a preposition Prep and a category C, to the number of different words Y, of category C, for which the dependency relationship (M, Prep, Y) has been identified.

17. Method according to one of claims 14 or 15, characterized in that the productivity coefficients include a governed productivity coefficient that corresponds, for a triplet constituted by a word M, a preposition Prep and a category C, to the number of different words X, of category C, such that the dependency relationship (X, Prep, M) has been identified.

18. Method according to any one of claims 14 to 17, characterized in that the stage of endogenous learning also includes a processing of first-order syntactic contexts each corresponding to a pair (M, REL) where M is a word and REL is a dependency relationship.

19. Method according to any one of claims 14 to 18, characterized in that the endogenous learning stage also includes a processing of second-order syntactic contexts each corresponding to a quadruplet (M₁, M₂, REL₁ and REL₂) where M₁, and M₂ are words, and REL₁ and REL₂ relationships of dependence.

20. Method according to claims 18 and 19, characterized in that the endogenous learning stage also includes, for two words X, Y of the same category, a determination of a governed proximity coefficient between said two words X, Y:
governed proximity (X, Y)=a₁. N₁(X, Y)+a₂. N₂(X, Y)
where N₁(X, Y) is the number of first-order syntactic contexts in which X and Y have each been found, and N₂ (X, Y) is the number of second-order syntactic contexts in which X an Y have each been found.

21. Method according to claims 18 and 19 or claim 20, characterized in that the endogenous learning stage also includes a determination, for two first and second syntactic contexts (M₁,R₁) and (M₂,R₂), of a governor proximity coefficient equal to the number of words found in said first syntactic context and in said second syntactic context.

22. Method according to any one of the preceding claims, characterized in that the endogenous learning stage (2) is followed by a stage (3) of marking of the candidates, in which for each ambiguous case, each of the candidates is reviewed and is marked with one of the indicators, the values of which are calculated from data acquired during the endogenous learning phase.

23. Method according to claim 22, characterized in that during the stage (3) of marking, each candidate of each of the cases is assigned direct indicators calculated from data acquired from the candidate and from the pivot word themselves and derived indicators calculated from data acquired from morphological derived words linked to the candidate or to the pivot word.

24. Method according to claim 23, characterized in that the stage (3) of marking is followed by a stage (4) of resolution by default of the residual ambiguity cases if the data acquired during the endogenous learning stage (2) have not contributed to marking any candidate during the stage (3) of marking.

25. System of broad syntactic analysis on unsupervised learning on a corpus, using the process according to any one of the preceding claims, characterized in that it includes means of acquiring linguistic data on the unambiguous analysis cases, and means of resolving the ambiguous analysis cases comprising means of processing said acquired linguistic data.

26. System according to claim 25, characterized in that the data-acquisition means are set up to distinguish between unambiguous analysis cases and ambiguous analysis cases, and in that the processing means are set up to process the ambiguous analysis cases and to provide data allowing residual ambiguity cases to be resolved.

27. Use of the syntactic analysis method according to one of claims 1 to 24, for the construction of specialized terminological resources for a data-processing system.

28. Use of the method of syntactic analysis according to one of claims 1 to 24, for the construction of an ontology for a specialized-information search engine on the web.

29. Use of the method of syntactic analysis according to one of claims 1 to 24, for the construction of a terminological lexicon for an automatic translation system.

30. Use of the method of syntactic analysis according to one of claims 1 to 24, for the construction of a thesaurus for an automatic indexing system.
